(19) United States
(12) Patent Application Publication
(10) Pub. No.: US 2020/0165732 A1
(43) Pub. Date: May 28, 2020

(54) METHOD AND SYSTEM FOR PRODUCING A GAS PRODUCT CONTAINING CARBON MONOXIDE

(71) Applicant: Linde Aktiengesellschaft, München (DE)

(72) Inventors: Andreas PESCHEL, Wolfratshausen (DE); Benjamin HENTSCHEL, München (DE)

(21) Appl. No.: 16/621,093

(22) PCT Filed: May 30, 2018
(86) PCT No.: PCT/EP2018/000280

§ 371 Date: Dec. 10, 2019

(30) Foreign Application Priority Data
Jun. 14, 2017 (DE) 10 2017 005 681.1

(51) Int. Cl. C25B 1/00; C01B 32/40; B01D 53/047; B01D 53/04; C25B 15/08; B01D 53/22

(52) U.S. Cl. CPC C25B 1/00; C01B 32/40; B01D 53/047; B01D 2257/504; C25B 15/08; B01D 53/229; B01D 2256/20; B01D 53/0462

(57) ABSTRACT

The invention relates to a method (100, 200) for producing a gas product (D) containing at least carbon monoxide, in which method at least carbon dioxide is subjected to an electrolysis process (10) in order to obtain a raw gas (A) containing at least carbon monoxide and carbon dioxide and the carbon dioxide contained in the raw gas (A) is partially or completely fed back to the electrolysis process (10), characterized in that the raw gas (A) is partially or completely subjected to an adsorption process (20) in order to obtain the gas product (D), which is enriched in carbon monoxide and depleted of carbon dioxide in comparison with the raw gas (A), and a residual mixture (E), which is depleted of carbon monoxide and enriched in carbon dioxide in comparison with the raw gas (A), and that the residual mixture (E) is at least partially subjected to a membrane separation process (30) in order to obtain a first gas mixture (B) as a retentate and a second gas mixture (H) as a permeate, the first gas mixture (B) at least partially being fed back to the adsorption process (20) together with the raw gas (A) or with the portion thereof subjected to the adsorption process (20), and the second gas mixture (H) at least partially being fed back to the electrolysis process (10). The invention further relates to a corresponding system.

The present invention relates to a method and to a system for producing a gas product containing at least carbon monoxide according to the respective preambles of the independent claims.

### PRIOR ART

Carbon monoxide can be produced by means of a number of different processes, e.g., together with hydrogen by steam reforming of natural gas and subsequent purification from the formed synthesis gas, or by the gasification of starting materials, such as coal, petroleum, natural gas, or biomass and subsequent purification from the formed synthesis gas. In addition to the production of carbon monoxide or carbon monoxide-rich gas mixtures, the present invention also relates to the production of synthesis gas, i.e., in general, the production of gas products that may contain at least carbon monoxide, but also further components typically present in synthesis gas—in particular, hydrogen.

The electrochemical production of carbon monoxide from carbon dioxide is likewise known and appears to be attractive in particular for applications in which the classical production by steam reforming is over-designed and thus uneconomical. In particular, high-temperature (HT) electrolysis, which is carried out using one or more solid oxide electrolysis cells (SOEC), can be used for this purpose. Oxygen forms on the anode side, and carbon monoxide forms on the cathode side, according to the following reaction equation:

CO₂→CO+½O₂ (1)

As a rule, carbon dioxide is not completely converted into carbon monoxide during the electrochemical production of carbon monoxide from carbon dioxide during a single pass through the electrolysis cell(s), so that carbon dioxide is typically separated at least partially from a gas mixture formed during the electrolysis process and fed back to the electrolysis process.

The explained electrochemical production of carbon monoxide from carbon dioxide is described, for example, in WO 2014/154253 A1, WO 2013/131778 A2, WO 2015/014527 A1, and EP 2 940 773 A1. A separation of a gas mixture formed during the electrolysis process using absorption, adsorption, membrane, and cryogenic separation processes is likewise disclosed in the cited publications, but no details are provided as to the specific design and, in particular, as to a combination of the processes.

In solid oxide electrolysis cells, water, as well as carbon dioxide, can also be subjected to the electrolysis process so that a synthesis gas containing hydrogen and carbon monoxide can be formed. Details in this regard are provided, for example, in an article, published online before going to print, by Foit et al. (2016), Angew. Chem., DOI: 10.1002/ange.201607552. Such methods can also be used within the scope of the present invention and are referred to hereafter as HT co-electrolysis.

The electrochemical production of carbon monoxide from carbon dioxide is also possible by means of low-temperature (LT) electrolysis on aqueous electrolytes (also referred to herein as LT co-electrolysis). The following reactions take place in the process:

CO₂+2e⁻+2M⁺+H₂O→CO+2MOH (2)

2MOH→½O₂+2M⁺+2e⁻+H₂O (3)

In the case of a corresponding LT co-electrolysis, a membrane is used, through which the positive charge carriers (M⁺) required according to reaction equation 2, or formed according to reaction equation 3, migrate from the anode side to the cathode side. In contrast to HT electrolysis using solid oxide electrolysis cells, the positive charge carriers here are not transported in the form of oxygen ions, but rather, for example, in the form of positive ions of the electrolyte salt used (a metal hydroxide, MOH). An example of a corresponding electrolyte salt might be potassium hydroxide. In this case, the positive charge carriers are potassium ions. Further embodiments of LT electrolysis include, for example, the use of proton exchange membranes (PEM) through which protons migrate, or of so-called anion exchange membranes (AEM). Different variants of corresponding methods are described, for example, in Delacourt et al. (2008) J. Electrochem. Soc. 155(1), B42-B49, DOI: 10.1149/1.2801871.

The presence of water in the electrolyte solution also partially results in the formation of hydrogen at the cathode:

2H₂O+2M⁺+2e⁻→H₂+2MOH (4)

Depending on the catalyst used, additional useful products can also be formed during LT co-electrolysis. In particular, LT co-electrolysis can be carried out to form different amounts of hydrogen. Corresponding methods and devices are described, for example, in WO 2016/124300 A1 and WO 2016/128323 A1. However, suitable separation concepts for the gas mixtures formed during a corresponding electrolysis process and process concepts in connection with the electrolysis process have not yet been described in the literature.

The aim of the present invention is therefore to show concepts for separating corresponding gas mixtures, which, in addition to carbon monoxide and carbon dioxide, can also contain hydrogen.

### SUMMARY OF THE INVENTION

Against this background, the present invention proposes a method for producing a gas product containing at least carbon monoxide and a corresponding system having the features of the respective independent patent claims. Preferred embodiments are the subject matter of the dependent claims and the following description.

As already mentioned, a “gas product containing at least carbon monoxide” here is understood to mean, in particular, carbon monoxide of different purities or else synthesis gas or a comparable gas mixture, i.e., a gas mixture that contains at least also appreciable amounts of hydrogen, in addition to carbon monoxide. Further details are explained below.

For example, the gas product may contain hydrogen and carbon monoxide in equal or comparable fractions. The molar ratio of hydrogen to carbon monoxide in the gas product can, in particular, be in a range of 1:10 to 10:1, 2:8 to 8:2, or 4:6 to 6:4, wherein the molar fraction of hydrogen and carbon dioxide together can be above 50%, 60%, 70%, 80%, 90%, 95%, or 99%, and any potential remainder can be formed, in particular, of carbon dioxide or inert-behaving gases, such as nitrogen or inert gases of the air. The molar ratio of hydrogen to carbon monoxide in the gas product can, in particular, be approximately 1 or approximately 2 or approximately 3, and the stoichiometric number (see below) can, in particular, be approximately 2. If no or little hydrogen is present in the raw gas, the gas product is also accordingly poor in or free from hydrogen, and is thus a gas product rich in carbon monoxide or pure carbon monoxide.

In particular, the raw gas formed during the electrolysis process may—particularly in the non-aqueous fraction (i.e., “dry”)—have a content of 0 to 60% hydrogen, 10 to 90% carbon monoxide, and 10 to 80% carbon dioxide.

An essential aspect of the present invention is to obtain a raw gas from the electrolysis process—which, due to the electrolysis conditions used, contains at least carbon monoxide and carbon dioxide, but may also contain hydrogen—using an adsorption process—in particular, pressure swing adsorption (PSA) or temperature swing adsorption (TSA). The electrolysis process can be performed as pure carbon dioxide electrolysis or as co-electrolysis.

The gas product and a gas mixture referred to here as the “residual mixture” are formed during the adsorption process. The former is, in particular, highly depleted of carbon dioxide, since this adsorbs on the adsorption material used during the adsorption process. Carbon monoxide is distributed, in particular, between the gas product and the residual mixture, wherein the proportions can be influenced by the selection of corresponding adsorption conditions and adsorption materials. In contrast, hydrogen, if present, largely passes into the gas product. The gas product is, therefore, poor in or free from carbon dioxide and can be predominantly or exclusively composed of carbon monoxide and, optionally, hydrogen. The gas product contains, for example, less than 5%, 4%, 3%, 2%, 1%, 0.1%, 1,000 ppm, 100 ppm, 10 ppm, or 1 ppm of carbon dioxide on a molar basis and contains, otherwise or in the fractions already mentioned above, hydrogen and carbon monoxide and any non-adsorbing, inert components and impurities.

A further essential aspect of the present invention is to feed back portions of the residual mixture (referred to herein as the “first gas mixture” and “second gas mixture”) to the electrolysis process (together with a fresh feed) and to the adsorption process (together with the raw gas), wherein the respective portions or the first gas mixture and the second gas mixture are fractions that can be obtained by means of a membrane process or a membrane separation process. By adapting the fractions or the contents thereof of, in particular, carbon monoxide and carbon dioxide, advantageous conditions can thus be created at the inlet of the electrolysis process on the one hand, and of the adsorption process on the other, and carbon monoxide and carbon dioxide can be fed back to the adsorption process or to the electrolysis process in a targeted or more targeted manner. It is thus advantageous to feed carbon monoxide present in the residual mixture back into the adsorption process, so as to ultimately pass it into the gas product. Feeding the carbon monoxide back to the electrolysis process can lead to material problems during preheating. However, feeding portions of the hydrogen, if present, back to the electrolysis process can provide advantages in terms of material stability—especially in the case of HT electrolysis. The carbon dioxide present in the residual mixture can, advantageously, be fed back to the electrolysis process; however, too great a proportion at the inlet of the adsorption process typically has a disadvantageous effect on the yields during the adsorption process.

Overall, the present invention makes it possible to increase the fraction of carbon monoxide at the inlet of the adsorption process in a targeted manner, and to correspondingly reduce the fraction of carbon dioxide. The lower fraction of carbon dioxide leads to an increase in the yield of carbon monoxide during the adsorption process and results in better operating conditions, since a high fraction of the adsorbing component can be problematic from an operational perspective.

A further advantage is a reduced fraction of carbon monoxide in the recycle to the electrolysis process, which can have a favorable effect on the electrolysis efficiency, depending upon the design of the electrolysis process.

An essential aspect of the present invention is the use of the aforementioned membrane separation downstream of the formation of the aforementioned gas product and of the residual mixture by means of the adsorption process. The residual mixture formed during the adsorption process, in addition to the gas product, is processed by means of the membrane separation downstream of the adsorption process.

The residual mixture accumulates at the desorption pressure level of the pressure swing adsorption process if pressure swing adsorption is employed, and is, for example, fed back to the membrane separation process after appropriate compression to a pressure level referred to herein as the retentate pressure level. In the case of a temperature swing adsorption, the discharge pressure of the residual mixture can be higher than in the case of the pressure swing adsorption, for which reason a corresponding compressor between the adsorption process and membrane separation can, optionally, be dispensed with. During the membrane separation, a retentate mixture is obtained at the retentate pressure level, which is depleted of carbon dioxide and enriched in carbon monoxide in comparison with the residual mixture, and which is therefore fed back (in the form of the first gas mixture) at least partially to the adsorption process. Furthermore, a permeate mixture is obtained at a permeate pressure level during the membrane separation process, which is enriched in carbon dioxide and depleted of carbon monoxide in comparison with the residual mixture, and which is fed back (in the form of the second gas mixture) at least partially to the electrolysis process. If present, hydrogen may be distributed between the retentate and permeate in accordance with the membrane selected.

Within the scope of the present application, a “permeate” is understood to mean a mixture predominantly or exclusively comprising components that are not, or predominantly not, retained by a membrane used in a membrane separation process, i.e., which pass through the membrane (substantially, or at least preferably) unimpeded. Within the scope of the invention, a membrane is used which preferably retains carbon monoxide. In this way, the permeate is enriched at least in carbon dioxide. Such a membrane is, for example, a commercial polymer membrane, which are used on an industrial scale for separating carbon dioxide and/or hydrogen. Accordingly, a “retentate” is a mixture predominantly comprising components that are retained completely or at least predominantly by the membrane used in the membrane separation process. A passage of hydrogen (if present) can be set by the choice of membrane. In particular, a carbon dioxide-selective membrane can also be used within the scope of the present invention. A carbon dioxide selective membrane is, in particular, described in Lin, H. et al. (2014), J. Membr. Sci. 457(1), 149-161, DOI: 10.1016/j.memsci.2014.01.020. In this way, it is possible for a permeate of the membrane separation process to be substantially composed of carbon dioxide.

Within the scope of the present, the carbon dioxide electrolysis or co-electrolysis can take place in the form of an HT electrolysis process using one or more solid oxide electrolysis cells, or as an LT co-electrolysis process, e.g., using a proton exchange membrane and an electrolyte salt in aqueous solution—in particular, a metal hydroxide. In principle, the LT co-electrolysis can be carried out using different liquid electrolytes, e.g., on an aqueous basis—in particular, with electrolyte salts—on a polymer basis, or in other embodiments. If HT electrolysis is used, water can additionally be supplied to the solid oxide electrolysis cell or cells, so that co-electrolysis takes place and hydrogen is formed. During LT co-electrolysis, the presence of water typically causes a certain, but variable degree of hydrogen formation, as a function of the particular specific design of the process.

By selecting a suitable membrane in the membrane separation used according to the invention and by suitably dimensioning (surface area) a corresponding membrane, it can be ensured that the respectively desired contents of carbon monoxide and carbon dioxide are created in the first and the second gas mixtures.

Within the scope of the present invention, a simple, cost-effective, and technically uncomplicated, on-site production of carbon monoxide or synthesis gas by carbon dioxide electrolysis according to one of the explained techniques is possible. In this way, carbon monoxide or synthesis gas can be provided to a consumer, without having to resort to the known methods, such as steam reforming, which may be over-designed. The production on site makes it possible to dispense with a cost-intensive and potentially unsafe transport of carbon monoxide or synthesis gas. Within the scope of the present invention, the flexible purification of an electrolysis raw product, or of a raw gas provided by means of electrolysis, which is predominantly composed of carbon monoxide and carbon dioxide and, optionally, hydrogen and water, to yield carbon monoxide products of different purity levels, or to yield synthesis gas, while feeding carbon dioxide back to the electrolysis process, is possible.

Overall, the present invention proposes a method for producing a gas product containing at least carbon monoxide, in which at least carbon dioxide is subjected to electrolysis to obtain a raw gas containing at least carbon monoxide and carbon dioxide. With regard to the electrolysis methods that can be used within the scope of the present invention, reference is made to the above explanations. The present invention is described below with, in particular, reference to the LT co-electrolysis of carbon dioxide and water; however, HT co-electrolysis, for example, in which hydrogen is likewise present in the raw gas, can also be readily used, if, for example, water is also subjected to the electrolysis process.

As a result, when it is mentioned here that “at least carbon dioxide” is subjected to the electrolysis process, this does not preclude further components of a feed mixture, which can be used within the scope of the present invention and supplied to the electrolysis process, from also being subjected to the electrolysis process. As was explained at the outset, this can be, in particular, water, which can be converted to hydrogen and oxygen. In this way, a gas mixture comprising the typical components of synthesis gas can be obtained, as was also explained above. In particular, in the case of HT co-electrolysis, supplying hydrogen and carbon monoxide to the electrolysis process can have a positive effect on the service life of the electrolysis cell.

Any gas mixture that is provided, using an electrolysis process to which carbon dioxide is (also, but not exclusively) subjected, is referred to as “raw gas” in the language used herein. In addition to the components mentioned, the raw gas can also contain, for example, oxygen or unconverted inert components, wherein, here and hereafter, “inert” components shall be understood to mean not only the traditional inert gases, but all compounds not converted in a corresponding electrolysis process. The electrolysis process carried out within the scope of the present invention can be carried out using one or more electrolysis cells, one or more electrolyzers, each having one or more electrolysis cells, or one or more other structural units used for electrolysis.

As is generally known, but only described in general form in the prior art, carbon dioxide contained in the raw gas can be partially or completely fed back to the electrolysis process to improve the yield of a corresponding process. In this context, it is also true that, when it is mentioned here that “carbon dioxide” is fed back to the electrolysis process, this does not preclude further components from also being fed back, purposefully or unintentionally, to the electrolysis process, e.g., by partially directly recirculating raw gas, without separation of certain components, as will also be explained below. A corresponding recirculation can, optionally, take place in the method according to the invention, but is not a prerequisite for achieving the advantages according to the invention.

Within the scope of the present invention, it is provided that the raw gas be partially or completely subjected to an adsorption process to obtain the gas product, which is enriched in carbon monoxide and depleted of carbon dioxide in comparison with the raw gas, and a residual mixture, which is depleted of carbon monoxide and enriched in carbon dioxide in comparison with the raw gas. Within the scope of the present invention, the residual mixture is, furthermore, subjected at least partially to a membrane separation process to obtain a first gas mixture as a retentate and a second gas mixture as a permeate, wherein the first gas mixture is fed back at least partially to the adsorption process together with the raw gas or with the portion thereof subjected to the adsorption process, and the second gas mixture is at least partially fed back to the electrolysis process. Further details have already been explained in more detail above.

In general, material flows, gas mixtures, etc., may, in the language used herein, be rich or poor in one or more components, wherein the specification, “rich,” may represent a content of at least 50%, 60%, 75%, 80%, 90%, 95%, 98%, 99%, 99.5%, 99.9%, or 99.99%, and the specification, “poor,” may represent a content of at most 50%, 40%, 25%, 20%, 10%, 5%, 2%, 1%, 0.5%, 0.1%, or 0.01% on a molar, weight, or volume basis. If several components are specified, the specification, “rich” or “poor,” refers to the sum of all components. For example, if “carbon monoxide” is mentioned here, this may refer to a pure gas, but also a mixture rich in carbon monoxide. A gas mixture “predominantly” containing one or more components is, in particular, rich in this component or these components in the sense described.

In the language used herein, material flows, gas mixtures, etc., may furthermore be “enriched” in or “depleted” of one or more components, with these terms referring to a content in a starting mixture. They are “enriched” if they have a content of at least 1.1 times, 1.5 times, 2 times, 5 times, 10 times, 100 times, or 1,000 times, and “depleted” if they have a content of no more than 0.9 times, 0.75 times, 0.5 times, 0.1 times, 0.01 times, or 0.001 times, of one or more components, relative to the starting mixture.

Within the scope of the present invention, at least one fresh feed predominantly or exclusively containing carbon dioxide can be fed to the electrolysis process, in addition to the second gas mixture. This fresh feed can contain, for example, over 90%, 95%, 99%, 99.9%, or 99.99% carbon dioxide on a molar basis. The stated values apply when a carbon monoxide-rich gas mixture or pure carbon monoxide is to be formed as the gas product. If synthesis gas is to be formed as the gas product, water and carbon dioxide are typically supplied to the electrolysis process in a ratio that corresponds to the later or desired ratio of hydrogen and carbon monoxide in said gas product.

As already mentioned, within the scope of the present invention, the use of a membrane separation process downstream and in addition to a separation process by adsorption can, in particular, prevent carbon dioxide from being fed back to the adsorption process in undesirably high amounts.

In one embodiment of the method according to the invention, the membrane separation comprises at least two membrane separation steps, wherein the permeate comprises permeate fractions each formed in the at least two membrane separation steps. According to one embodiment of the present invention, it can also be provided that the membrane separation process comprise at least two membrane separation steps, and that the permeate of a downstream membrane separation step be fed back to an upstream membrane separation step so as to increase the carbon monoxide yield, while increasing the pressure by means of a compressor. According to a further embodiment of the present invention, it can also be provided that the membrane separation process comprise at least two membrane separation steps, and that the permeate of an upstream membrane separation step be fed to a downstream membrane separation step, while increasing the pressure by means of a compressor. In the downstream membrane separation step, a retentate mixture is obtained, which is fed back to is subjected to an upstream membrane separation step in order to increase the carbon monoxide yield.

It is particularly advantageous within the scope of the present invention that at least a portion of the residual mixture be discharged from the process. For example, it can be provided within the scope of the present invention that a partial flow in the form of a so-called purge be branched off the residual mixture—in particular, upstream of the membrane separation process and, possibly, the corresponding compression. The components contained in a corresponding purge are discharged from the process and thus withdrawn from the process. The discharging—in particular, of inert-behaving components—can prevent these from accumulating in the cycles formed by the recirculation.

In particular, it can be provided within the scope of the present invention that only a first fraction of the raw gas be fed to the adsorption process, and that a second fraction of the raw gas be fed back to the electrolysis, bypassing the adsorption process (and, advantageously, further apparatuses, i.e., “directly”). This proves to be particularly advantageous when pressure swing adsorption is used. Since a corresponding second fraction has to be compressed to only a small extent (only the low pressure loss during the electrolysis process has to be overcome), whereas a significantly higher pressure difference has to be overcome for the recirculation of the first and second gas mixtures that are formed from the residual mixture of the pressure swing adsorption (the desorption pressure level is typically just above 1 bar (see also below), while the electrolysis pressure level is significantly higher), compressor capacity can be conserved in this way.

Within the scope of the present invention, it is provided that the electrolysis process be carried out at the aforementioned electrolysis pressure level, and that the adsorption be carried out at an adsorption pressure level, the adsorption pressure level being either at the electrolysis pressure level or above the electrolysis pressure level. The adsorption pressure level is in this case “at” the electrolysis pressure level if it differs therefrom by no more than 1, 2, 3, or 5 bar. In the event that the adsorption pressure level is “above” the electrolysis pressure level, in contrast, a pressure difference of, in particular, more than 5 and up to 25 bar is present.

The electrolysis process can thus be operated either at the (inlet or upper) pressure level of the adsorption process (which, in the case of pressure swing adsorption, is, for example, 10 to 80 bar, and preferably 10 to bar) or at a lower pressure level. In the first case, the raw gas does not have to be compressed or must be compressed only to a small extent; however, at least the portion of the residual mixture that is fed back to the electrolysis process, i.e., the residual mixture or the first and/or second gas mixtures, is compressed, because the residual mixture leaves the adsorption process at the distinctly lower desorption pressure level in the case of pressure swing adsorption. In the second case, the raw gas or the portion thereof that is fed back to the adsorption process must, prior to adsorption, be compressed from the electrolysis pressure level to the adsorption pressure level. In this case, however, compression of the recirculated portion may, optionally, be dispensed with.

In the first embodiment, less compression energy is generally required, and the compressor or compressors used can have a smaller design (since, not the entire raw gas, but only the residual mixture or a portion thereof has to be compressed). In contrast, in the second embodiment, the electrolysis process may be performed more easily. Both variants are therefore selected by the person skilled in the art as a function of the priority or by considering the individual advantages.

Within the scope of the present invention, a raw gas having a content of 5 to 95% hydrogen, 5 to 95% carbon monoxide, and 5 to 80% carbon dioxide is, advantageously, formed. Furthermore, as mentioned, a synthesis gas may be formed as the gas product in the method, wherein the gas product contains 5 to 95% carbon monoxide and 5 to 95% hydrogen, or has a hydrogen to carbon monoxide ratio of 1:10 to 10:1 and a carbon dioxide content of less than 10%. The ratio of hydrogen to carbon monoxide may also be approximately 1 to 4, or the gas product may have a stoichiometric number of 0.8 to 2.1, the gas product containing in total 90 to 100%—in particular, 95 to 100%, and, advantageously, 99 to 100%—carbon monoxide and hydrogen. The stoichiometric number SN is calculated from the molar fractions x of hydrogen, carbon dioxide, and carbon monoxide as SN=(x H₂-x CO₂)/(x CO+x CO₂). Further specifications have already been provided above. Alternatively, a carbon monoxide-rich gas mixture may be formed as the gas product, wherein the gas product contains 90 to 100%—in particular, 95 to 100%, e.g., 98 to 100%—carbon monoxide.

The present invention also covers a system for producing a gas product containing at least carbon monoxide according to the corresponding independent claim.

Regarding features and advantages of the system proposed according to the invention, reference is expressly made to the above explanations regarding the method according to the invention and the embodiments thereof. This also applies to a system according to a particularly preferred embodiment of the present invention, which is designed to carry out a method as was described above in the embodiments thereof.

The invention is explained in more detail below with reference to the accompanying drawings, which illustrate preferred embodiments of the present invention.

### BRIEF DESCRIPTION OF THE DRAWINGS

FIG. 1 illustrates a method according to an embodiment of the invention;

FIG. 2 illustrates a method according to an embodiment of the invention; and

FIG. 3 illustrates a method not according to the invention.

In the figures, method steps, technical units, apparatuses, and the like that correspond to one another in terms of function and/or design or structure are denoted by identical reference signs and, for the sake of clarity, are not explained again. Although methods according to embodiments of the invention are illustrated in the drawings and will be explained in more detail below, the corresponding explanations apply similarly to systems configured according to embodiments of the invention. As a result, where method steps are explained hereafter, these explanations apply similarly to system parts.

### DETAILED DESCRIPTION OF THE DRAWINGS

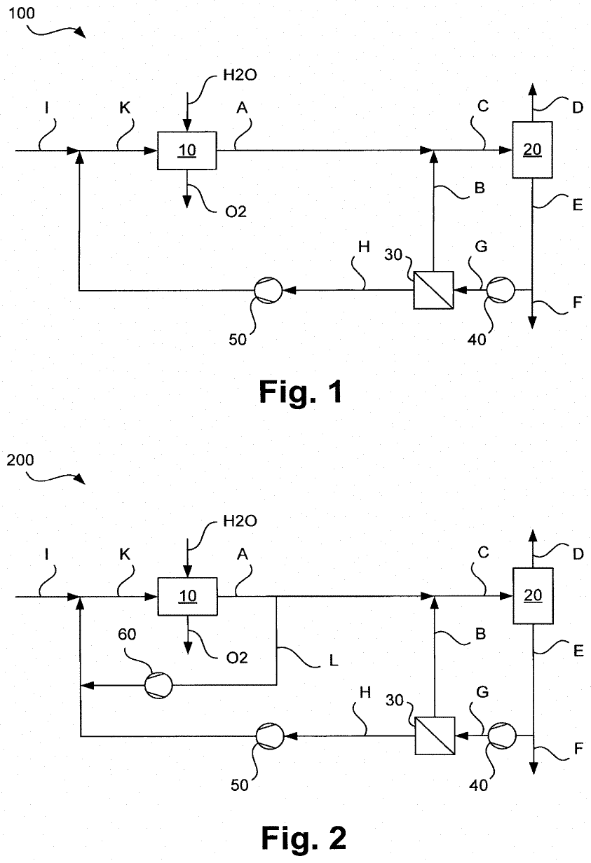

FIG. 1 schematically illustrates a method according to an embodiment of the invention, which is denoted overall by 100.

An electrolysis process 10 is provided as an essential method step of the method 100, which can be carried out, in particular, in the form of HT co-electrolysis using one or more solid oxide electrolysis cells and/or LT co-electrolysis on an aqueous electrolyte, as was explained at the outset in each case. Mixed forms of such electrolysis techniques can also be used within the scope of the present invention. In particular, the electrolysis process 10 may be carried out using one or more electrolysis cells, groups of electrolytic cells, and the like. A feed in the form of a material flow K supplied to the electrolysis process 10 is explained below. This feed comprises carbon dioxide, which is partially converted to carbon monoxide in the electrolysis process 10. In this way, using the electrolysis process 10, a raw gas A is obtained, having a composition that depends on the feeds supplied to the electrolysis process 10 and the electrolysis conditions.

Within the scope of the embodiment of the present invention illustrated in FIG. 1, a water or vapor flow H₂O is also fed to the electrolysis process 10, wherein the water thus provided is also reacted in the electrolysis process 10 (see, for example, reaction equation 3 in the introductory part). In this way, an oxygen-rich material flow O₂ can be removed from the anode side, and carbon monoxide and hydrogen are formed on the cathode side and in this way pass into the raw gas A.

The raw gas A contains hydrogen, carbon monoxide, and carbon dioxide. The hydrogen and carbon monoxide present in raw gas A are target products of the method 100. The carbon dioxide present in the raw gas A is the carbon dioxide that was fed to the electrolysis process 10, but was not converted there.

In the example shown, the raw gas A contains, for example, approximately 31% hydrogen, 32% carbon monoxide, and 37% carbon dioxide. In the example shown, it is formed, for example, in an amount of 177 standard cubic meters per hour and fed completely to a pressure swing adsorption process 20. The raw gas A is present at a pressure of approximately 20 bar, for example. In the example shown, the electrolysis process 10 is carried out at, for example, a temperature of 30° C. The temperatures used in a corresponding electrolysis process 10 are, for example, in a range of approximately 20 to 80° C. Complete conversion of the carbon dioxide during the electrolysis process 10 is generally not desirable in order to protect the electrolysis material, or is not possible in terms of the reaction kinetics, whereby unreacted carbon dioxide is present in the raw gas A.

During the pressure swing adsorption process 20, the raw gas A is processed together with a retentate mixture B of a membrane method 30, with which the raw gas A is combined beforehand to form a collection flow C. The retentate mixture B is provided, for example, in an amount of approximately 30 standard cubic meters per hour. It contains, for example, approximately 0.1% hydrogen, 80% carbon monoxide, and 20% carbon dioxide. The collection flow C is therefore present in an amount of, for example, approximately 207 standard cubic meters per hour. It contains, for example, approximately 27% hydrogen, 39% carbon monoxide, and 35% carbon dioxide.

During the pressure swing adsorption process 20, a gas product D and a residual mixture E are formed. For example, the gas product D is provided in an amount of approximately 100 standard cubic meters per hour. It contains, for example, approximately 50% hydrogen, 50% carbon monoxide, and 100 ppm carbon dioxide. For example, the residual mixture E is provided in an amount of approximately 107 standard cubic meters per hour. It contains, for example, approximately 5% hydrogen, 28% carbon monoxide, and 67% carbon dioxide. In other words, the predominant fraction of the hydrogen passes from the collection flow C into the gas product, whereas the predominant fraction of the carbon dioxide passes into the residual mixture E. The residual mixture E is provided at a pressure level of approximately 1.2 bar, for example.

A portion of the residual mixture E, illustrated here in the form of a material flow F, may be discharged from the process 100 (purge) to prevent an accumulation of inert-behaving components. The remainder is compressed in the form of a material flow G in one or more compressors 40.

The material flow G is processed at a pressure level of approximately bar, for example, to obtain the aforementioned retentate mixture B, which is enriched in carbon monoxide and depleted of carbon dioxide and hydrogen in comparison with the residual mixture E, and a permeate mixture H, which is depleted of carbon monoxide and enriched in carbon dioxide and hydrogen in comparison with the residual mixture E. The permeate mixture H is provided, for example, at a pressure level of approximately 2 bar. The amount thereof is, for example, approximately 77 standard cubic meters per hour, the content of hydrogen thereof is, for example, approximately 6%, that of carbon monoxide is, for example, approximately 8%, and that of carbon dioxide is, for example, approximately 85%. The pressure level of the retentate mixture B is, for example, approximately 20 bar. Alternatively, it is also possible to use a membrane which retains hydrogen and carbon monoxide and preferably allows carbon dioxide to pass.

In the embodiment shown in FIG. 1, the permeate mixture H is recompressed in one or more compressors 50 and fed back to the electrolysis process 10 together with a fresh feed flow I as collection flow K. The fresh feed flow I is provided, for example, in an amount of approximately 50 standard cubic meters per hour, and the carbon dioxide content thereof is, for example, over 99.9%. In addition, an amount of 50 standard cubic meters per hour of water or steam is also required here for a desired gas product. The amount of collection flow K is therefore, for example, approximately 128 standard cubic meters per hour. The collection flow K contains, for example, approximately 4% hydrogen, 5% carbon monoxide, and 91% carbon dioxide.

So as to set the temperature in the electrolysis process 10 and other process steps, a heat exchange, for example, can be carried out upstream and/or downstream of the electrolysis process 10, which can be realized both as a feed-effluent exchanger with heat exchange between the inlet flow K and raw gas flow A, and also by means of external heat media. This is not illustrated in FIG. 1. A water separation process is also not illustrated, within the scope of which water vapor present in the raw gas A can be condensed out and, if necessary, fed back to the electrolysis process 10. After such a water separation process, renewed heating—typically by approximately 5 to 20° C.—can also be carried out upstream of the pressure swing adsorption process 20 so that the temperature level of the raw gas A is above the dew point.

So as to reduce possible oxygen fractions in the gas product D, a catalytic deoxo reactor can also be installed in the flow of raw gas A in order to remove oxygen. By selecting suitable catalysts, hydrogen oxidizes to water starting at 70° C., for example, and carbon monoxide oxidizes to carbon dioxide starting at 150° C. This also applies to the methods 200 and 300 explained below.

FIG. 2 schematically illustrates a method according to a further embodiment of the invention, which is denoted overall by 200.

The method 200 illustrated in FIG. 2 differs, in particular, from the method 100 illustrated in FIG. 1 in that a portion of the raw gas A, as illustrated here in the form of a material flow L, is fed back directly to the electrolysis process 10, i.e., is not subjected to the pressure swing adsorption process 20, but is fed to the material flow H or K. In other words, here (only), a first fraction of the raw gas A is combined with the retentate mixture B and subjected to the pressure swing adsorption process 20, whereas a second fraction of the raw gas A is fed back directly to the electrolysis process 10.

The fraction of carbon monoxide in the material flow K fed to the electrolysis process 10 can be increased by appropriate partial recirculation. In this way, the content of carbon monoxide in the electrolysis raw product, and thus the raw gas A, can be increased. This may have a positive effect on the overall separation sequence of the method 200. Since only the pressure loss of the electrolysis unit in which the electrolysis process 10 is carried out has to be overcome for appropriate recirculation, an inexpensive fan can be used as the compressor 60.

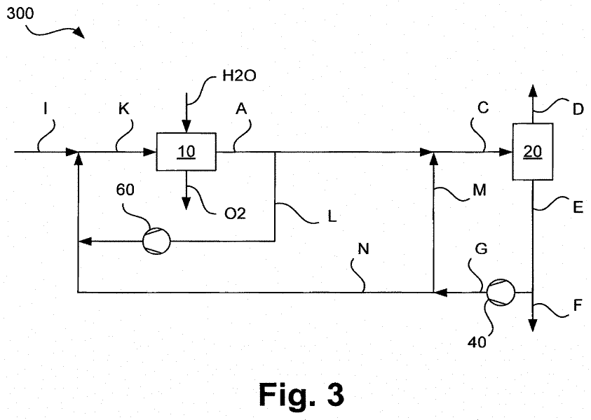

FIG. 3 schematically illustrates a method not according to the invention, which is denoted overall by 300.

The method 300 illustrated in FIG. 3 differs, in particular, from the method 200 previously explained and illustrated in FIG. 2 in that no membrane separation process 30 is carried out here. The compressor 50 can also be dispensed with in this way. Thus, no “retentate mixture” B is formed here. Instead, a material flow denoted by M here, and a material flow denoted by N here, are formed as partial flows of the same material composition. The material flow M is used like the retentate flow B of the methods 100 and 200 illustrated in FIGS. 1 and 2, and the use of the material flow N corresponds to that of the material flow H in these methods 100 and 200.

1. Method (100, 200) for producing a gas product (D) containing at least carbon monoxide, in which method at least carbon dioxide is subjected to an electrolysis process (10) in order to obtain a raw gas (A) containing at least carbon monoxide and carbon dioxide, and the carbon dioxide contained in the raw gas (A) is partially or completely fed back to the electrolysis process (10), characterized in that the raw gas (A) is partially or completely subjected to an adsorption process (20) in order to obtain the gas product (D), which is enriched in carbon monoxide and depleted of carbon dioxide in comparison with the raw gas (A), and a residual mixture (E), which is depleted of carbon monoxide and enriched in carbon dioxide in comparison with the raw gas (A), and that the residual mixture (E) is at least partially subjected to a membrane separation process (30) in order to obtain a first gas mixture (B) as a retentate and a second gas mixture (H) as a permeate, the first gas mixture (B) being at least partially fed back to the adsorption process (20) together with the raw gas (A) or with the fraction thereof subjected to the adsorption process (20), and the second gas mixture (H) being at least partially fed back to the electrolysis process (10).

2. Method (100, 200) according to claim 1, wherein the adsorption process (20) comprises a pressure swing adsorption process and/or a temperature swing adsorption process.

3. Method (100, 200) according to claim 1, wherein the first gas mixture (B) is enriched in carbon monoxide and depleted of carbon dioxide in comparison with the residual mixture (E), and the second gas mixture (H) is depleted of carbon monoxide and enriched in carbon dioxide in comparison with the residual mixture (E).

4. Method (500) according to claim 1, wherein the membrane separation process (30) comprises at least two membrane separation steps, the first gas mixture comprising retentate fractions, each formed in the at least two membrane separation steps, and the second gas mixture comprising permeate fractions, each formed in the at least two membrane separation steps.

5. Method (100-300) according to claim 1, wherein a portion of the residual mixture is discharged from the method (100-300).

6. Method (100-300) according to claim 1, wherein a first fraction of the raw gas (A) is fed to the adsorption process (20), and a second fraction of the raw gas (A) is fed back to the electrolysis process (10), bypassing the adsorption process (20).

7. Method (100-300) according to claim 1, wherein the electrolysis process (10) takes place at an electrolysis pressure level, and the adsorption process (20) takes place at an adsorption pressure level.

8. Method according to claim 7, wherein the adsorption pressure level differs by no more than 1, 2, 3, or 5 bar from the electrolysis pressure level, the residual mixture (E) and/or the first and/or the second gas mixtures (B, H) being compressed to the electrolysis pressure level.

9. Method according to claim 7, wherein the adsorption pressure level is 5 to 30 bar above the electrolysis pressure level, the raw gas (A) or the fraction thereof subjected to the adsorption process (20) being compressed to the adsorption pressure level.

10. Method (100-300) according to claim 1, wherein synthesis gas is formed as the gas product (D), the gas product (D) containing 20 to 100% carbon monoxide and 0 to 80% hydrogen and being poor in or free of carbon dioxide.

11. Method (100-300) according to claim 1, wherein the raw gas (A) has a content of 0 to 60% hydrogen, 10 to 90% carbon monoxide, and 10 to 80% carbon dioxide in the non-aqueous fraction.

12. Method (100-500) according to claim 1, wherein the electrolysis process (10) in the form of a high-temperature electrolysis process using one or more solid oxide electrolysis cells and/or a low-temperature co-electrolysis process is carried out on a liquid electrolyte.

13. System for producing a gas product (D) containing at least carbon monoxide, comprising an electrolysis unit configured to subject at least carbon dioxide to an electrolysis process (10) in order to obtain a raw gas (A) containing at least carbon monoxide and carbon dioxide, and comprising means configured to feed the carbon dioxide present in the raw gas (A) partially or completely back to the electrolysis process (10), characterized by means configured to partially or completely subject the raw gas (A) to an adsorption process (20) in order to obtain the gas product (D), which is enriched in carbon monoxide and depleted of carbon dioxide in comparison with the raw gas (A), and a residual mixture (E), which is depleted of carbon monoxide and enriched in carbon dioxide in comparison with the raw gas (A), means configured to at least partially subject the residual mixture (E) to a membrane separation process (30) in order to obtain a first gas mixture (B) as a retentate and a second gas mixture (H) as a permeate, means configured to at least partially feed the first gas mixture (B) back to the adsorption process (20) together with the raw gas (A) or with the fraction thereof subjected to the adsorption process (20), and means configured to feed the second gas mixture (H) at least partially back to the electrolysis process (10).

14. System according to claim 13, comprising means configured to carry out a method (100, 200) for producing a gas product (D) containing at least carbon monoxide, in which method at least carbon dioxide is subjected to an electrolysis process (10) in order to obtain a raw gas (A) containing at least carbon monoxide and carbon dioxide, and the carbon dioxide contained in the raw gas (A) is partially or completely fed back to the electrolysis process (10), characterized in that the raw gas (A) is partially or completely subjected to an adsorption process (20) in order to obtain the gas product (D), which is enriched in carbon monoxide and depleted of carbon dioxide in comparison with the raw gas (A), and a residual mixture (E), which is depleted of carbon monoxide and enriched in carbon dioxide in comparison with the raw gas (A), and that the residual mixture (E) is at least partially subjected to a membrane separation process (30) in order to obtain a first gas mixture (B) as a retentate and a second gas mixture (H) as a permeate, the first gas mixture (B) being at least partially fed back to the adsorption process (20) together with the raw gas (A) or with the fraction thereof subjected to the adsorption process (20), and the second gas mixture (H) being at least partially fed back to the electrolysis process (10).
